(19) United States
(12) Patent Application Publication
(10) Pub. No.: US 2025/0061312 A1
(43) Pub. Date: Feb. 20, 2025

(54) Knowledge Graphs for Dynamically Generating Content Using a Machine-Learned Content Generation Model

(71) Applicant: Google LLC, Mountain View, CA (US)

(72) Inventors: Matthias Heiler, Zug (CH); Sylvanus Garnet Bent, III, Palo Alto, CA (US); Mehmet Levent Koc, Redwood City, CA (US); Snehal Sunilkumar Motarwar, Bengaluru (IN); Aravindan Raghuveer, Bangalore (IN); Saachi Grover, Bangalore (IN); Nidhi Gupta, Bangalore (IN); Preksha Nema, Vijaynagar (IN); Durga Deepthi Singh Sharma, Bangalore (IN); Abhinav Khandelwal, Bengaluru (IN)

(21) Appl. No.: 18/764,501

(22) Filed: Jul. 5, 2024

(30) Foreign Application Priority Data
Aug. 15, 2023 (IN) 202321054722

(51) Int. Cl. G06N 3/0475

(52) U.S. Cl. CPC G06N 3/0475

(57) ABSTRACT

Example aspects of the present disclosure provide an example method. In some implementations, the example method can include receiving request data indicating a request for content. In some implementations, the example method can include determining a request context associated with the request data, wherein the request context is based on account data for a user device associated with the request. In some implementations, the example method can include determining, based on the request and the request context, a data object from a knowledge graph, wherein the data object comprises a subject and one or more attributes for the subject. In some implementations, the example method can include generating, using a machine-learned content generation model, content descriptive of the subject, the content generated based on the request, the request context, and the data object.

### PRIORITY

The present application is based on and claims priority to Indian Provisional Application 20/232,1054722, which was filed Aug. 15, 2023, and which is hereby incorporated by reference herein in its entirety.

### FIELD

The present disclosure relates generally to knowledge graphs. More particularly, the present disclosure relates to knowledge graphs providing structured inputs for machine-learned content generation models.

### BACKGROUND

A multi-modal, multi-platform distribution system can distribute content items to various endpoints to facilitate communication with various audiences. The content items can contain data or other information or messages. The content items can be or include media assets. A user can initiate communications by providing the multi-modal, multi-platform distribution system with a set of content items for distribution.

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include receiving request data indicating a request for content. In some implementations, the example method can include determining a request context associated with the request data, wherein the request context is based on account data for a user device associated with the request. In some implementations, the example method can include determining, based on the request and the request context, a data object from a knowledge graph, wherein the data object comprises a subject and one or more attributes for the subject. In some implementations, the example method can include generating, using a machine-learned content generation model, content descriptive of the subject, the content generated based on the request, the request context, and the data object.

Example aspects of the present disclosure provide one or more example non-transitory computer-readable media storing instructions that are executable by one or more processors to cause a computing system to perform operations, the operations comprising the example method.

Example aspects of the present disclosure provide an example computing system that includes one or more processors and the one or more example non-transitory computer-readable media.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example content generation pipeline according to example embodiments of the present disclosure.

FIG. 2a depicts a block diagram of example data according to example embodiments of the present disclosure.

FIG. 2b depicts a block diagram of example data according to example embodiments of the present disclosure.

FIG. 3 depicts a block diagram of an example knowledge graph generation pipeline according to example embodiments of the present disclosure.

FIG. 4 depicts a block diagram of an example entity preferences interface according to example embodiments of the present disclosure.

FIG. 5 depicts a block diagram of an example computing system that performs content generation for a request according to example embodiments of the present disclosure.

FIG. 6 depicts a bock diagram of an example computing system that performs validation of generated content according to example embodiments of the present disclosure.

FIG. 7 depicts a flow chart diagram of an example method to generate content according to example embodiments of the present disclosure.

FIG. 8 is a flow chart diagram illustrating an example method for training a machine-learned model according to example implementations of aspects of the present disclosure.

FIG. 9 is a block diagram of an example processing flow for using machine-learned model(s) to process input(s) to generate output(s) according to example implementations of aspects of the present disclosure.

FIG. 10 is a block diagram of an example sequence processing model according to example implementations of aspects of the present disclosure.

FIG. 11 is a block diagram of an example technique for populating an example input sequence for processing by a sequence processing model according to example implementations of aspects of the present disclosure.

FIG. 12 is a block diagram of an example model development platform according to example implementations of aspects of the present disclosure.

FIG. 13 is a block diagram of an example training workflow for training a machine-learned model according to example implementations of aspects of the present disclosure.

FIG. 14 is a block diagram of an inference system for operating one or more machine-learned model(s) to perform inference according to example implementations of aspects of the present disclosure.

FIG. 15 is a block diagram of an example networked computing system according to example implementations of aspects of the present disclosure.

FIG. 16 is a block diagram of an example computing device according to example implementations of aspects of the present disclosure.

FIG. 17 is a block diagram of an example computing device according to example implementations of aspects of the present disclosure.

Reference numerals that are repeated across plural figures are intended to identify the same features in various implementations.

### DETAILED DESCRIPTION

### Overview

Generally, the present disclosure is directed to serving machine-generated content in response to content requests by generating the content based on the request and the context of the request. For example, example implementations can retrieve information from a knowledge graph to guide generation of the content with structured information regarding relevant subject matter. An example knowledge graph can contain information from one or more communicating entities regarding various subjects. Advantageously, the communicating entities can exercise control over the use of the information in the knowledge graph for generating content. In this manner, for instance, end users can receive high-quality content that is customized for them while also satisfying communications requirements of the communicating entities.

In one example, a user can browse the internet on a user device. The user can submit a search query to a computing system. The user device can also submit a request for additional content to serve along with the results of the search query. The computing system can determine a context associated with the browsing session (e.g., a location, the weather). The computing system can reference account data associated with the user device (e.g., an account indicating one or more preferences). Based on these signals, the computing system can reference a structured data store (e.g., a knowledge graph) to determine a subject relevant to a task or activity the user is performing (e.g., a shopping task) and one or more attributes of the subject pertinent to the user in view of the context. The computing system can use this contextual information as well as the information from the knowledge graph to generate content to service the request for additional content. For instance, the computing system can generate audiovisual content that describes various aspects of a subject pertinent to the user's task. This content can be served to the user device for presentation to the user.

In some embodiments, a computing system may receive a request from a user device. The request from the user device may be associated with a search query. Along with the request, the computing system may receive request context associated with the request. For example, the request context may be a time, date, or location from when the request was made. With the request context, the computing system may determine an environment state associated with the request (e.g., it is raining and cold where the request was made). Additionally, the computing system may obtain account data associated with the request. For instance, the request may be associated with account data indicative of preferences for generating content such as, for example, content types, activity interests, brand preferences, previous purchases, etc. The account data may also be indicative of restrictions for generating content. For example, the account data may include a restriction to use no account data when generating content.

The computing system may determine a subject for the content and one or more attributes associated with the subject with which to generate content on. For instance, the computing system may use a knowledge graph to determine a product (e.g., subject) to generate the content from based on features of the product (e.g., one or more attributes) and the account data and request context. The computing system may generate content based on the subject and one or more attributes associated with the subject using a machine learned content generation model. For example, the computing system may determine a product with particular features from the knowledge graph as a target and generate content using a machine learned model based on the product and its particular features. In some instances, the request context and account data may be used to generate content to better tailor the content to the request. The computing system may then output the content for display on the user device.

In some embodiments, the computing system may determine if cached content within a content database may satisfy the request for content made by the user device. For instance, the computing system may receive a request for content and request context and check if content already generated may satisfy the request based on the request and request context (e.g., the computing system already generated content for a similar request and request context, so the computing system can reuse the already generated content rather than generate new content).

In some embodiments, the computing system may generate a portion of the knowledge graph based on a web resource of a merchant. For example, the computing system may receive a web resource such as, for example, a Uniform Resource Locator (URL). In response to receiving the web resource, the computing system may crawl the web pages associated with the web resource and extract content (e.g., text, images, audio, and video data) from the web pages. The computing system may determine a subject from the extracted content and one or more attributes associated with the extracted content. For example, the computing system may determine a product and features associated with the product (e.g., color, size, processing power, battery life, taste, etc.) from content extracted from a merchant's product page. In some instances, the merchant may be an attribute of the one or more attributes associated with the subject.

In some embodiments, the computing system may obtain subjects and attributes from a merchant's web resources based on a merchant's preferences. For instance, a merchant may have configured one or more preferences such that certain subjects or features of its product are unavailable to the computing system. More specifically, a merchant may indicate that a particular web resource or type of extracted content is off limits for the computing system (e.g., by modifying a robots.txt file).

In one embodiment, the computing system may output a user interface for the entity such that the entity may configure its preferences. Within the user interface, the entity may be able to select things the computing system can or cannot extract, as well as what the computing system can or cannot generate based on a subject or attributes. For example, an entity may be within an industry with strict guidelines for how a product or service may be conveyed. The entity, using the user interface, may indicate such guidelines such that the computing system abides by the guidelines when obtaining subject and attributes or generating content associated with a subject or one or more attributes. In one embodiment, the entity's preferences may be based on the request context of a request. More specifically, the entity may configure preferences for what the computing system may extract or generate based on the context of a request. For example, an entity may set its preferences to prioritize generation of content of hot meals on its menu when the request context indicates that it is cold and rainy.

Example embodiments of the present disclosure provide several technical effects, benefits, and/or improvements in computing technology and artificial intelligence techniques that involve the use of machine learning algorithms to generate new data, such as images, audio, text, video, or other types of media. The techniques described herein can improve the functionality of computing systems that use generative models by providing a structured framework for controlling content generation. Generated content can be tailored specifically to an entity (e.g., company, user) by using data extracted from a web resource of the entity.

In some examples, the use of a structured framework can facilitate validation of the generated content against the framework. For example, after generation of the content, the content can be parsed to determine agreement between the generated content and the structured data. In this manner, for instance, example implementations can decrease hallucinations of models.

By using more content-relevant data, the computing system may also improve the performance of generative models. Additionally, the system utilizes better training techniques by developing more efficient and effective training techniques that are specific to the entity (e.g., based on data extracted from a web resource of the entity) to reduce the time and resources required to train models. For example, a smaller model may be trained that leverages structured inputs according to the present disclosure in lieu of training (at greater expense) a larger model that does not use the structured inputs to obtain the output content.

Furthermore, the present disclosure can reduce processing demands by reducing the number of manual inputs provided by a user and by reducing the number of interface screens which are obtained, loaded, interacted with, and updated to generate content otherwise. For example, an entity may provide a webpage associated with a line of products and then user-tailored content (e.g., advertisements) may be automatically generated for the products whenever a computing system receives a request that may be associated with their line of products.

With reference now to the Figures, example embodiments of the present disclosure will be discussed in further detail.

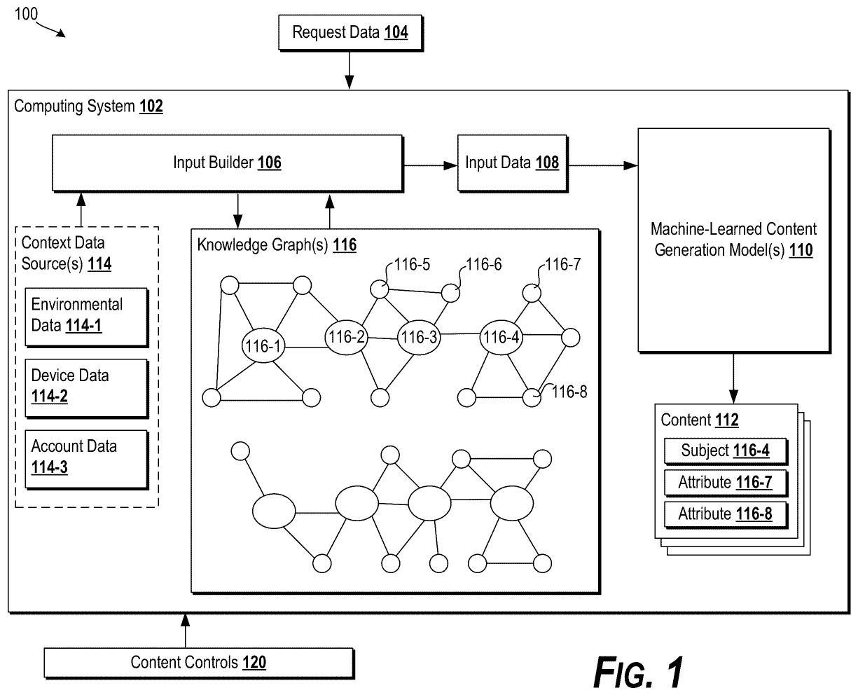

FIG. 1 illustrates a block diagram of an example content generation pipeline 100 according to example embodiments of the present disclosure. A computing system 102 can implement content generation pipeline 100. Computing system 102 can receive request data 104. Request data 104 can indicate a request for content (e.g., content to render on a user device). Computing system 102 can engage an input builder 106 to build an input data structure 108 for input to machine-learned content generation model(s) 110 to generate content 112. Input builder 106 leverage data from context data source(s) 114 and knowledge graph(s) 116 to generate input data 108. For instance, context data source(s) 114 can include environmental data 114-1, device data 114-2, account data 114-3, etc. Knowledge graph(s) 116 can include a structured representation of data descriptive of one or more subject(s) 116-1, 116-2, 116-3, 116-4, etc. For instance, knowledge graph(s) 116 can include one or more attributes 116-5, 116-6, 116-7, 116-8, etc. that are associated with corresponding subjects. Input builder 106 can extract data from knowledge graph(s) 116 based on request data 104 and data from context data source(s) 114. Input data 108 built based on knowledge graph(s) 116 can cause machine-learned content generation model(s) 110 to generate content 112 that includes features drawn from knowledge graph(s) 116. For instance, content 112 can include a subject 116-4 from knowledge graph(s) 116 and one or more attributes associated therewith, such as attribute 116-7 and attribute 116-8. Content controls 120 can cause computing system 102 to prioritize certain content or deprioritize certain content (e.g., based on a communicating entity associated with the content).

Content generation pipeline 100 can be implemented on one or more computing systems. Content generation pipeline 100 can be implemented by a single entity or cooperatively by several entities having computing systems communicatively coupled over a network. Content generation pipeline 100 can operate on a server computing system and provide content generation as a service to one or more client computing systems. For instance, content generation pipeline 100 can facilitate generation of content for web distribution to client endpoints. Content generation pipeline 100 can generate content on behalf of one or more communicating entities for distribution to one or more audiences. For instance, a communicating entity can provide instructions to cause content generation pipeline 100 to generate content that is configured to communicate prescribed information or to reach a prescribed audience. A communicating entity can generate one or more configuration files that describe one or more instructions for content generation pipeline 100. Content generation pipeline 100 can process the one or more configuration files to generate content according to the instructions.

Content generation pipeline 100 can generate content on-demand. Content generation pipeline 100 can generate content based on real-time requests for content received by computing system 102.

Computing system 102 can include one or more computing devices (e.g., as described herein). Computing system 102 can be implemented by a single entity or cooperatively by several entities having computing systems communicatively coupled over a network.

Computing system 102 can obtain request data 104 that was received via a network interface. For instance, computing system 102 can directly or indirectly receive request data 104 from a sending device.

Request data 104 can include data describing a request for content. Request data 104 can be communicated by a message received at a specified application programming interface endpoint. The request for content can be explicit or implicit. For instance, request data 104 can explicitly indicate that content is desired and can indicate one or more preferred characteristics of such content (e.g., content type, file type, size, duration, etc.). Request data 104 can implicitly indicate that content is desired, for instance by submitting one or more parameters that are understood by computing system 102 to be a request for content.

A request for content can be a request for supplemental content to accompany primary content. The primary content might not be available to or accessible by computing system 102. The primary content can be, for example, a web page (e.g., viewed in a browser application on a mobile or other computing device), an application interface (e.g., an interface of a native application containing content), a media item (e.g., a podcast, video stream, audio stream, etc.), etc. The primary content can define content slots for inserting supplemental content. The content slots can have one or more characteristics (e.g., size, shape, location, etc.). Executable code (e.g., embedded in the primary content or otherwise initiated by loading of the primary content) can trigger request data 104 to fetch supplemental content for the content slots.

A request for content can also include a request for primary content. For instance, the generated content can be passed to a device which renders the generated content as primary display content. For instance, the request for content can be initiated based on a search query for primary content (e.g., a search for product recommendations), and the generated content can be returned as a response to the search query.

Request data 104 can include context information indicating a context of the request. For instance, context information can include data indicating how the request was originated, the context within which the requested content will be rendered, etc.

For instance, requests can be generated while servicing a search operation for a query from a user device. For instance, a user device can submit a query to retrieve search results relevant to the query (e.g., from a search engine). The search results can be primary content. Request data 104 can be generated (e.g., by the user device, by a server device, etc.) to retrieve supplemental content to serve along with the primary content. To provide more relevant supplemental content, request data 104 can include data indicative of search query 210. A subject 212 of the query 210 can be identified, along with one or more attributes 214 of the subject 212. This context information can assist the content generation pipeline 100 in generating more relevant content.

Search query 210 can be a natural language query, a symbolic language query, or any other representation of a query for information. Search query 210 can be provided in an interpretable form or can be provided in an obscured form, such that the actual contents of search query 210 may or may not be known or knowable. For instance, search query 210 can be obtained in a format which allows operations to be performed on search query 210 without revealing exactly what information is contained within search query 210. For instance, search query 210 can include injected noise that obscures the actual query input by or on behalf of a user.

Subject 212 can be a semantic entity about which search query 210 seeks information. For instance, for a search query for “efficient car,” the subject can be “car.” Subject 212 can include the verbatim subject or a disambiguated or refined subject (e.g., “car” can be represented as “vehicle”). Subject 212 can be augmented to obscure exact query information. For instance, query terms can be mapped to a discretized vocabulary to omit more granular detail. Noise can be injected.

Subject 212 can include a plurality of subjects, where some of the subjects were added to obscure the identity of the true subject. For instance, for a true subject of “car,” subject 212 can include a set of subjects {“car”, “bicycle”, “food”} so that computing system 102 does not have knowledge of which subject is the true subject.

Attributes 214 can include one or more characteristics associated with subject 212 that are indicated in search query 210. Attributes 214 can provide a signal of what aspects of subject(s) 212 are of interest so that content generation pipeline 100 can generate content relevant to the interests driving the query. Like some implementations of subject 212, attributes 214 can be obscured, such as by injecting noise or augmenting attributes 214 with added attributes to obscure the actual attributes of the query.

With reference again to FIG. 1, computing system 102 can receive request data 104 and apply one or more machine-learned content generation model(s) 110 to service the request. Computing system 102 can use input builder 106 to generate an input data structure 108 to cause machine-learned content generation model(s) 110 to generate the desired content.

Input builder 106 can process request data 104 to identify relevant content features to specify in input data 108. Input builder 106 can be or include one or more machine-learned models, such as machine-learned language processing models (e.g., including natural and symbolic languages, such as computer code, etc.), image processing models, etc.

Input builder 106 can be configured to generate a prompt for prompting machine-learned content generation model(s) 110. Input builder 106 can operate a machine-learned prompt generation model to generate a prompt that is configured to induce desired output from machine-learned content generation model(s) 110. For instance, it may be desired for the machine-learned content generation model(s) 110 to present the information retrieved from knowledge graph 116 in a manner customized to adapt to a particular request.

Input builder 106 can process other data in addition to request data 104. For instance, input builder 106 can process data from context data source(s) 114 and knowledge graph(s) 116. Input builder 106 can process all context data from context data source(s) 114. Input builder 106 can select context data from context data source(s) 114. Input builder 106 can receive only the context data from context data source(s) 114 that were selected by another component (e.g., a context selection component). For instance, input builder 106 can receive a set of context data that has been filtered/pruned or otherwise modified to mask or obscure the underlying data. Input builder 106 can receive a set of context data that has been filtered/pruned or otherwise modified based on one or more preferences associated with a user device corresponding to request data 104.

Context data source(s) 114 can be or include databases that are part of or directly or indirectly accessible by computing system 102. Context data source(s) 114 can be compiled at request time (e.g., at a time of receiving request data 104), updated at request time, or maintained from some prior update time. Context data source(s) 114 can include data obtained from one or more user devices associated with request data 104 at request time or at one or more prior times. Context data source(s) 114 can include data obtained about one or more user devices associated with request data 104 at request time or one or more prior times.

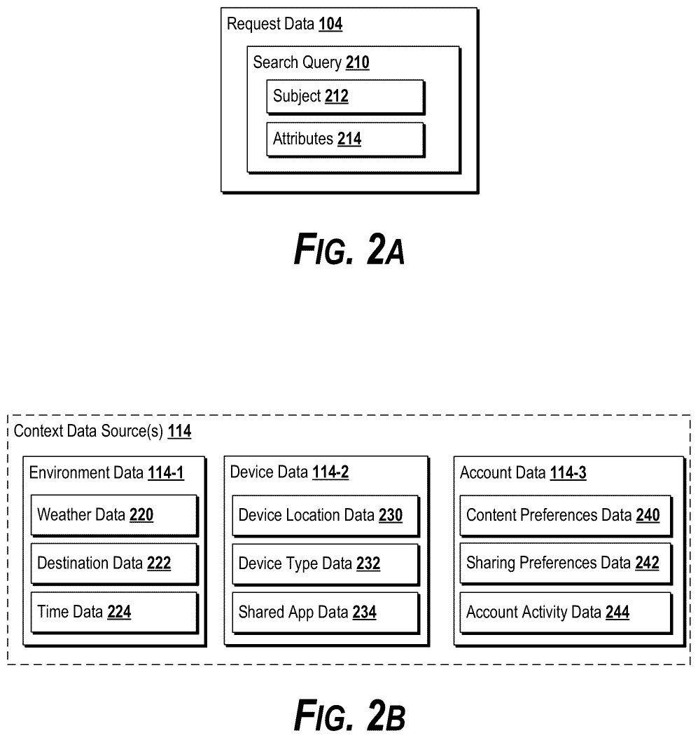

With reference to FIG. 2b, example types of context data source(s) 114 are presented.

Environmental data 114-1 can include data descriptive of an environment associated with a user device on which the requested content is to be displayed. The environment can be a present environment (e.g., an environment in which the user device is in use) or a future environment (e.g., an environment in which the user device is expected to be).

Environmental data 114-1 can include weather data 220. Weather data 220 can include data indicating one or more aspects of weather events and conditions in the environment. For instance, weather data 220 can include data indicating a precipitation level, temperature, humidity, wind speed, etc.

Environmental data 114-1 can include destination data 222. Destination data 222 can include data indicating one or more potential destinations to which the generated content could refer. For instance, destination data 222 can include data indicating physical locations or businesses in the environment. Destination data 222 can include one or more attributes of each destination. Destination data 222 can include, for example, data descriptive of available items at the destination, including current quantities of available items, etc.

Environmental data 114-1 can include time data 224. Time data 224 can include a current time, a time horizon, a schedule, etc. For instance, time data 224 can include a relevant time window within which the supplemental content will be most relevant. For example, recommendations for a restaurant that closes at 2:00 pm will generally not be highly relevant for supplemental content requested at 1:58 pm. Thus, a time window can be used as a context signal. Schedules can include open hours for businesses, event start/end times, public transportation route intervals, etc.

Device data 114-2 can include data descriptive of a user device associated with request data 104. Device data 114-2 can include data descriptive of a user device on which requested content is to be presented. Device data 114-2 can include data from or descriptive of one or more other user devices.

Device data 114-2 can include device location data 230. Device location data 230 can include a past, present, or estimated future location. Device location data 230 can include obfuscated location data. Device location data 230 can include absolute location data (e.g., a location tied to a geographic area). Device location data 230 can include relative location data (e.g., a location indicated with respect to one or more other locations). Device location data 230 can include semantic descriptions of location (e.g., “work,” “home,” etc.).

Device data 114-2 can include device type data 232. Device type data 232 can indicate a type of device on which the requested content is to be presented. Device type data 232 can indicate a type of device available to or otherwise accessible by a user associated with request data 104. Device type data 232 can indicate one or more capabilities of the corresponding device(s) to render content. Device type data 232 can indicate one or more capabilities of the corresponding device(s) to engage with one or more other systems (e.g., to facilitate a transaction, to initiate a service, etc.).

Device data 114-2 can include shared application data 234. Shared application data 234 can include data shared by one or more applications associated with a user device. Shared application data 234 can include, for instance, shared activities performed in an application (e.g., check-ins, badges, completed challenges, etc.). Shared application data 234 can include browsing or purchase histories. Shared application data 234 can by shared subject to user preferences.

Account data 114-3 can include data associated with a user account that are accessible to or indexed by content generation pipeline 100. For instance, content generation pipeline 100 can operate on a first-party system. The first-party system can maintain a register of active user accounts with the first-party system. A user account can be explicitly created or implicitly initiated via use of one or more systems (e.g., by engaging with content from content generation pipeline 100).

Account data 114-3 can include content preferences data 240. Content preferences data 240 can include data indicating one or more preferred or disfavored content types, subject matter, delivery styles, etc. For instance, a user account can be associated with certain subject matter areas of interest (e.g., outdoor activities, hair care, vegan food, etc.). A user account can be associated with certain subject matter areas that are not of interest (e.g., blocked subject matter, such as subject matter associated with sensitive topics).

Account data 114-3 can include data sharing preferences 242. Data sharing preferences 242 can include data indicating approval by the user for the use of data from context data source(s) 114. Data sharing preferences 242 can include indications of what level of accuracy or precision is allowed for context data (e.g., for location data, etc.).

Account data 114-3 can include account activity data 244. Account activity data 244 can include data describing historical activities associated with a user account. Account activity data 244 can include shopping history. Account activity data 244 can include a log of responses received to supplemental content (e.g., indications that one type of content is engaged more often than another type of content, and in what contexts).

With reference again to FIG. 1, knowledge graph 116 can include a structured representation of data describing various subjects. For instance, a data object can be stored in a node of the graph. The data object can contain at least one parent node associated with a subject (e.g., a product or service). The data object can contain, attached to the parent node, at least one child node associated with an attribute of the subject (e.g., a color, a dimension, a cost, a quantity, etc.). For example, FIG. 1 illustrates a number of parent nodes 116-1 to-4 with various child nodes 116-5 to-8.

The child nodes can be associated with multiple parent nodes. For instance, 116-5 is associated with both nodes 116-2 and 116-3. This can indicate, for example, that the subjects of nodes 116-2 and 116-3 share an attribute. In one example, the subjects can correspond to different models of mobile phones. Attribute 116-5 can be an attribute indicating an amount of megapixels of a sensor for a camera of the phones.

Knowledge graph 116 can be populated with data manually by an entity associated with the knowledge graph 116. Knowledge graph 116 can be populated automatically by parsing content associated with the entity.

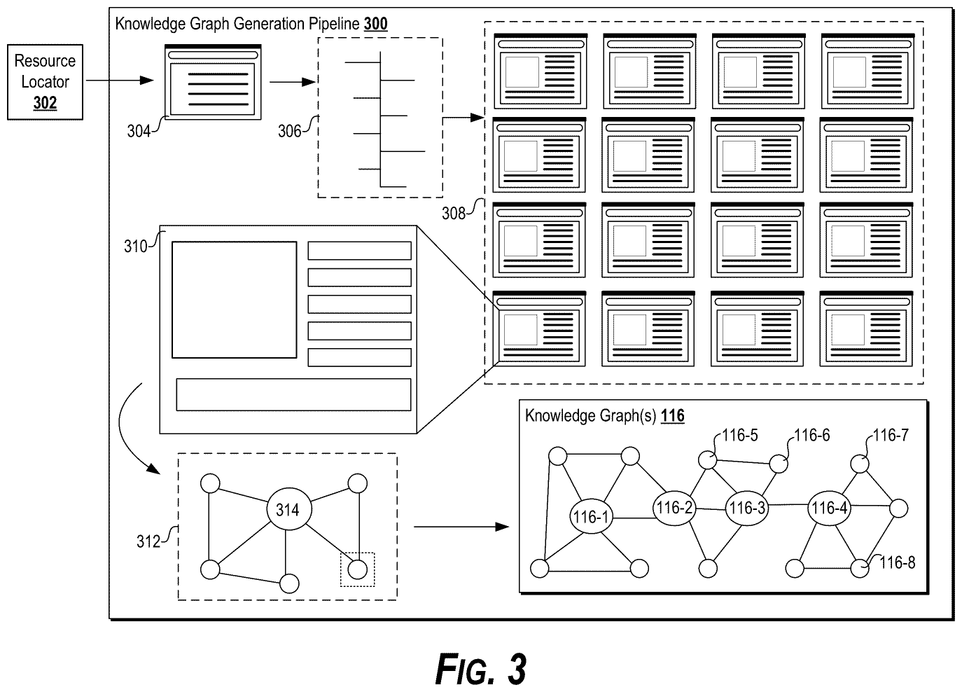

FIG. 3 depicts an example knowledge graph generation pipeline 300. The example knowledge graph generation pipeline 300 can receive a resource locator 302 that points to a web resource 304. The example knowledge graph generation pipeline 300 can build a site map 306 by traversing a structure of the web resource from root to leaf. The example knowledge graph generation pipeline 300 can extract a set of content pages 308 based on the site map and, for a respective page 310, generate a data object 312 that captures a subject 314 of the page and a number of attribute(s) for the subject 314. These data objects can be added to knowledge graph(s) 116.

Other example pipelines for processing input resource(s) to extract features for generating content are described in U.S. Provisional Patent Application No. 63/501, 191, filed May 10, 2023. U.S. Provisional Patent Application No. 63/501,191 is hereby incorporated by reference herein in its entirety.

With reference again to FIG. 1, input builder 106 can query knowledge graph 116 based on request data 104 and context data source(s) 114. For instance, input builder 106 can implement various graph query techniques to identify data objects in knowledge graph 116 that is relevant to request data 104 in view of context data source(s) 114. Input builder 106 can employ tree search techniques. Input builder 106 can employ distance-based similarity search techniques. Example similarity search techniques include searching based on similarities between embedded vectors, such as an embedding of the request and context data compared against an embedded vector for one or more portions of the graph. Input builder 106 can leverage message passing techniques on the graph to determine relevant data objects.

Input builder 106 can use one or more machine-learned models to generate a query to apply over knowledge graph(s) 116. For instance, input builder 106 can use a machine-learned model to predict subjects or attributes relevant to request data 104 in view of context data source(s) 114. For instance, request data 104 may be received from a restaurant booking application. Context data source(s) 114 can indicate that the weather is cold and rainy, and that an electric vehicle battery level is low. Input builder 106 can answer (explicitly, with a natural language processing model, or implicitly, by service of data corresponding to a prediction) the question, “what restaurant would one visit on a cold, rainy day when a vehicle recharge is needed?” Input builder 106 can obtain a query that contains an answer to this question (e.g., a query for subjects like restaurants having attributes including being nearby and having nearby electric vehicle charging facilities).

Input builder 106 can obtain a data object from knowledge graph 116 to add to input data 108. For instance, input builder 106 can receive a response to a query over knowledge graph 116. The response can contain a data object representing a subject node and one or more associated attributes. Input builder 106 can generate input data 108 to cause machine-learned content generation model(s) 110 to generate content describing the subject node and the one or more associated attributes. For instance, processing input data 108 can cause machine-learned content generation model(s) 110 to generate content 112 that describes a subject 116-4 and corresponding attribute 116-7 and attribute 116-8.

Input data 108 can include one or more data modalities. Input data 108 can include, for instance, any one or more of text data, image data, audio data, etc.

Machine-learned content generation model(s) 110 can be or include any type of machine-learned model that is configured to generate content based on provided instructions. Machine-learned content generation model(s) 110 can include, for instance, transformer models. Machine-learned content generation model(s) 110 can include, for instance, diffusion models. Machine-learned content generation model(s) 110 can be monolithic, with one large model that processes input data 108 and generates content 112. Machine-learned content generation model(s) 110 can include multiple models that cooperatively process an input. For instance, an input can be embedded using a first model that passes embedded instructions to a second model.

Content 112 can include one or more data modalities. Content 112 can include text content. Content 112 can include image content. Content 112 can include audio content. Content 112 can include video content or audiovisual content. For instance, content 112 can include text content that describes a subject and highlights one or more attributes of the subject based on the request and request context. Content 112 can include image data that depicts a subject according to one or more attributes of the subject (e.g., a color, a feature, a functionality, etc.). Content 112 can include video data illustrating use of a subject item or performance of a subject service.

Content 112 can be packaged with other data. For instance, content 112 can be packaged with a hyperlink to a web resource associated with a subject of content 112 (e.g., subject 116-4), such as a web resource descriptive of the subject. Content 112 can be configured for interaction, such that an interaction with content 112 can trigger an action (e.g., loading of the web resource). Interaction modalities can include a user input interface, an automated assistant interface, etc.

Content controls 120 can cause computing system 102 to prioritize certain content or deprioritize certain content (e.g., based on a communicating entity associated with the content). Content Controls 120 can include an entity selection, such that only subjects associated with the selected entity are input to input builder 106. An entity selection can be obtained from a real-time auction for the opportunity to serve content in response to request data 104. An entity selection can be obtained from a predetermined allotment or allocation of content slots.

Content controls 120 can include a rules-based system for determining what kind or type of content is to be generated for a respective entity. Content controls 120 can implement content curation based on themes or profiles associated with the respective entity. For instance, a brand profile can be used to control input data 108 to obtain content 112 that is consistent with a theme associated with the respective entity (e.g., a color scheme, a design language, etc.). Further example discussion of obtaining brand profiles and generating content based thereon is provided in U.S. Provisional Patent Application No. 63/501,191.

Content controls 120 can implement content filtering or prevention based on rules associated with the respective entity. For instance, certain entities may desire certain vocabulary to be used in association with communications regarding subjects associated with those entities. For instance, an entity that facilitates upscale dining experiences may desire that only elegant vocabulary is used, such that slang or other casual terminology can be omitted from content 112 (e.g., by including an instruction in input data 108 to avoid such terminology). Certain entities may be subject to regulatory restrictions on what statements can be made, or even what statements must be made (e.g., required disclaimers, clarifications, disclosures, etc.).

Content controls 120 can include a database of such configurations. Computing system 102 can retrieve configuration files corresponding to a determined entity when building an input 108 for content for that entity. Computing system 102 can pass the retrieved configuration files to input builder 106 so that input builder 106 can build input data 108 accordingly.

Content controls 120 can include one or more constraints on generated content. Constraints can be dimensional (e.g., size, duration, etc.). Constraints can be thematic (e.g., tone, style, etc.).

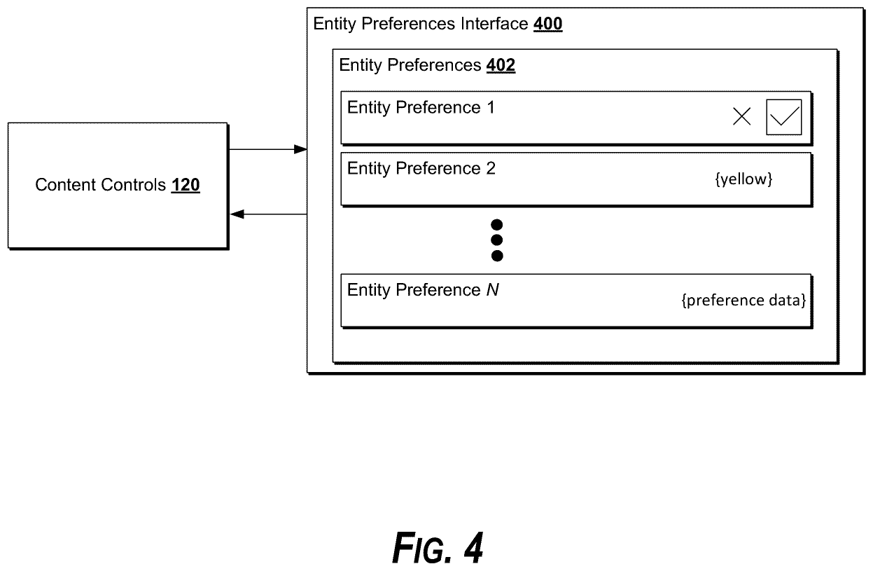

FIG. 4 depicts an example data flow for obtaining content controls 120 for an entity. A computing system can provide an entity preferences interface 400. The computing system can receive inputs corresponding to entity preferences 402. For example, for a first entity preference (e.g., a permission preference for using a certain type of imagery), a positive preference can be recorded. Other types of preferences can be obtained. For instance, a second entity preference can be a color family preference. Entity preferences 402 can include a response “yellow” for the second entity preference. In general, any number of entity preferences can be obtained and associated with preference data describing that preference. In this manner, for instance, input builder 106 can generate input data 108 according to the entity preferences.

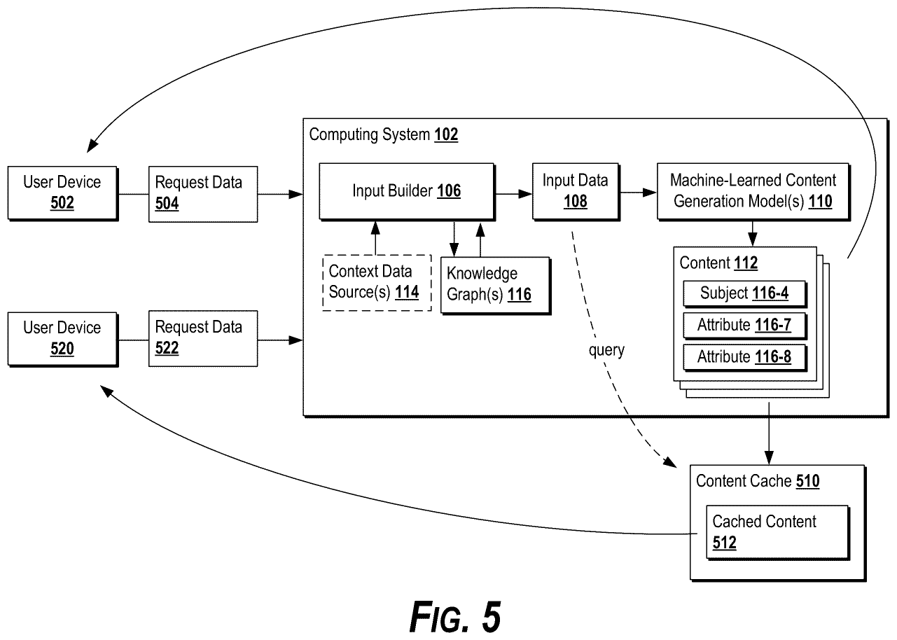

FIG. 5 depicts an example implementation for serving cached content. A user device 502 can send request data 504 to computing system 102. Computing system 102 can generate content 112 as described above. Computing system 102 can output content 112 for transmission to user device 502 responsive to request data 504.

Computing system 102 can also output content 112 to a content cache 510. Content cache 510 can be a short or long term storage component. Content cache 510 can include a database or other storage infrastructure. Content cache 510 can store content 112 as cached content 512. This cached content can be used to service later requests. For instance, in lieu of generating the same or similar content, the cached content can be served if the cached content has a sufficient relevance to the desired content.

For example, after content 112 is generated, another user device 520 can send request data 522 to computing system 102. Computing system 102 can process the request data 522 in view of context data from context data source(s) 114 and knowledge graph(s) 116 to determine input data 108. Because input data 108 can be descriptive of the desired content, input data 108 can be used to query content cache 510 to determine if there is any cached content 512 that is relevant to the input data determined for request data 522. It can be determined based on the query that cached content 512 satisfies a similarity threshold or other relevance metric. Based on this determination, cached content 512 can be served to user device 520.

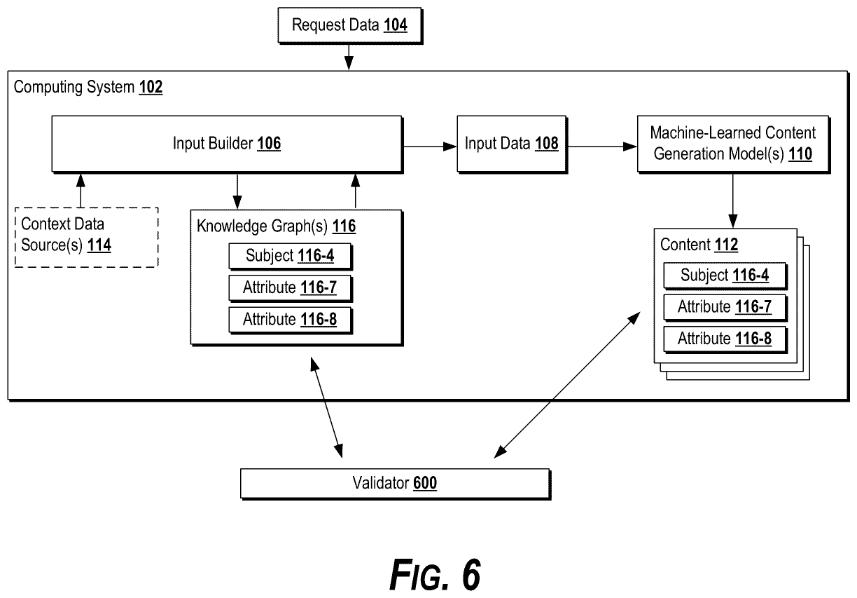

FIG. 6 depicts an example implementation of a validator 600. Validator 600 can process content 122 to identify subject(s) or attribute(s) in content 112 (e.g., using OCR, image processing techniques, audio processing techniques, etc.). Validator 600 can compare identified subject(s) or attribute(s) against the selected subject(s) or attribute(s) from knowledge graph(s) 116. For instance, validator 600 can receive a set of subject(s) or attribute(s) from input builder 106 and confirm whether the received subject(s) or attribute(s) are presented in content 112.

### Example Methods

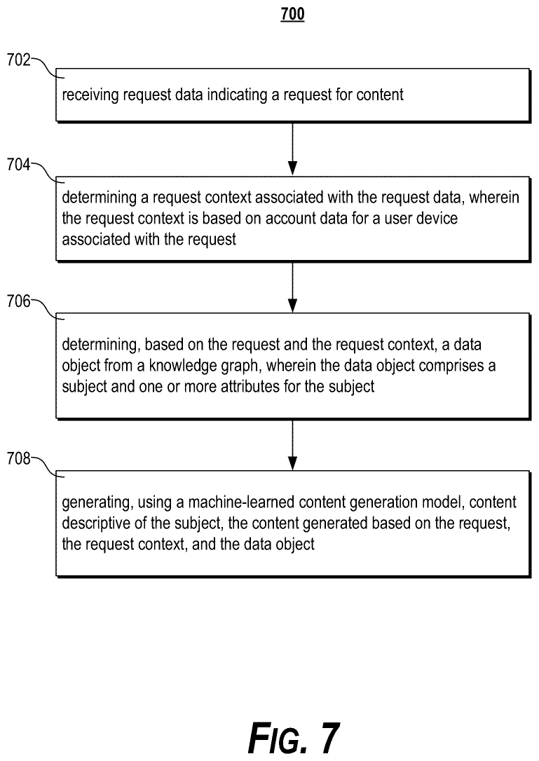

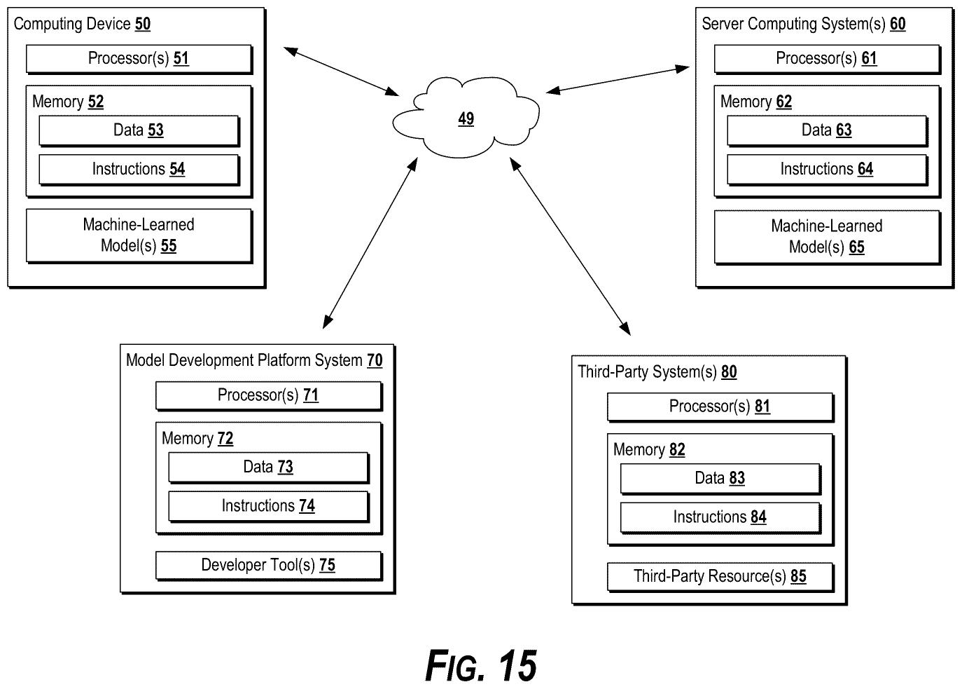

FIG. 7 depicts a flow chart diagram of an example method 700 to perform according to example embodiments of the present disclosure. Example method 700 can be implemented by one or more computing systems (e.g., one or more computing systems as discussed with respect to FIGS. 1 to 17, such as a model host 31 implemented by a computing device or system of FIG. 15). Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

In some implementations, at 702 example method 700 can include receiving request data indicating a request for content.

In some implementations, at 704 example method 700 can include determining a request context associated with the request data, wherein the request context is based on account data for a user device associated with the request;

In some implementations, at 706 example method 700 can include determining, based on the request and the request context, a data object from a knowledge graph, wherein the data object comprises a subject and one or more attributes for the subject; and

In some implementations, at 708 example method 700 can include generating, using a machine-learned content generation model, content descriptive of the subject, the content generated based on the request, the request context, and the data object.

In some implementations, example method 700 can include transmitting the content to the user device.

In some implementations, example method 700 can include generating, based on the request and the request context, input data for input to the machine-learned content generation model, wherein the input data is configured to cause the content generated by the machine-learned content generation model to describe the subject using the one or more attributes for the subject.

In some implementations, example method 700 can include generating, using a machine-learned model and based on the request data and the request context, a query for querying the knowledge graph to obtain the data object.

In some implementations, example method 700 can include obtaining preferences associated with an entity corresponding to the content. In some implementations, example method 700 can include generating the content according to the preferences.

In some implementations, example method 700 can include providing a user interface that facilitates entry of the preferences.

In some implementations of example method 700, the subject is a product or service offered by the entity.

In some implementations of example method 700, the content is packaged with a hyperlink to a web resource associated with the entity.

In some implementations, example method 700 can include processing the generated content to verify that it is consistent with the preferences.

In some implementations of example method 700, processing the generated content to verify that it is consistent with the preferences includes processing image data with an optical character recognition system to extract text.

In some implementations of example method 700, processing the generated content to verify that it is consistent with the preferences includes processing audio data with a speech recognition system to extract text.

In some implementations of example method 700, processing the generated content to verify that it is consistent with the preferences includes parsing text of the generated content to compare against the preferences.

In some implementations of example method 700, processing the generated content to verify that it is consistent with the preferences includes parsing text of the generated content to identify any excluded terms.

In some implementations, example method 700 can include, based on detecting a deviation from the preferences, initiating regeneration of the content.

In some implementations of example method 700, processing the generated content to verify that it is consistent with the preferences includes processing at least one of image data or audio data to determine compliance with at least one of: visual preferences or audio preferences.

In some implementations of example method 700, initiating regeneration includes editing the input data for the machine-learned content generation model.

In some implementations of example method 700, editing the input data for the machine-learned content generation model includes updating a prompt to include an instruction regarding the detected deviation.

In some implementations of example method 700, editing the input data for the machine-learned content generation model includes updating a prompt to include an instruction to correct the detected deviation.

In some implementations of example method 700, editing the input data for the machine-learned content generation model includes updating a prompt to include an instruction providing the detected deviation as a negative example.

In some implementations, example method 700 can include parsing the generated content to compare against the input data.

In some implementations, example method 700 can include parsing data comprising at least one of: text of the generated content, image data of the generated content, or audio data of the generated content. In some implementations, example method 700 can include comparing the parsed data with at least one of: the input data, the request data, the request context, or a portion of the data object.

In some implementations, example method 700 can include parsing the generated content to identify the subject and the one or more attributes.

In some implementations of example method 700, the request context includes data indicative of an environment in which the user device is located.

In some implementations, example method 700 can include generating the knowledge graph.

In some implementations of example method 700, generating the knowledge graph includes receiving a starting page indicative of an entity's webpage.

In some implementations of example method 700, generating the knowledge graph includes traversing a plurality of pages associated with the starting page.

In some implementations of example method 700, generating the knowledge graph includes obtaining the subject and the one or more attributes for the subject based on at least a portion of the plurality of pages, wherein at least one of the one or more attributes is the entity.

In some implementations of example method 700, generating the knowledge graph includes generating the data object comprising the subject and one or more attributes for the subject.

In some implementations of example method 700, generating the knowledge graph includes storing the data object in the knowledge graph based on the one of the one or more attributes that is the entity.

In some implementations of example method 700, obtaining the subject and the one or more attributes for the subject is performed by processing webpage content with a machine-learned model to output the subject and the one or more attributes.

In some implementations of example method 700, obtaining the subject and the one or more attributes for the subject includes determining, based on one or more preferences associated with the entity, an authorization to obtain the subject and the one or more attributes.

In some implementations, example method 700 can include caching the generated content. In some implementations, example method 700 can include serving the cached generated content to another user device based on determining a relevance between request data for the other user device and the cached generated content.

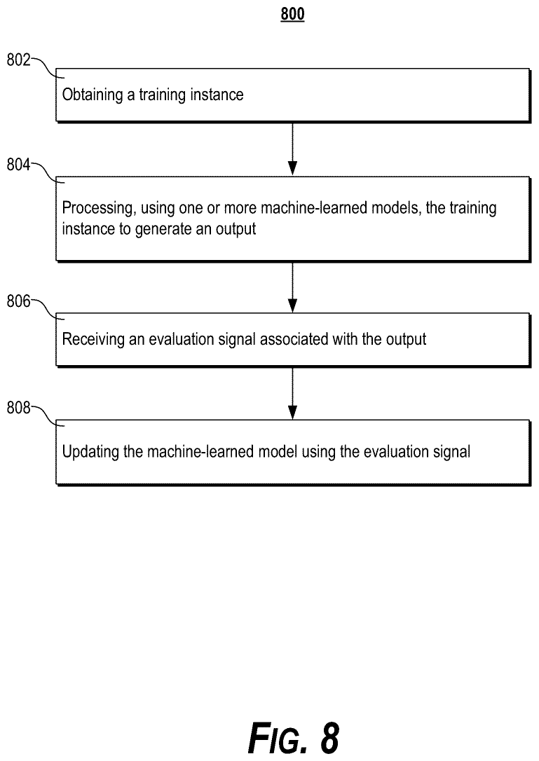

FIG. 8 depicts a flowchart of a method 800 for training one or more machine-learned models according to aspects of the present disclosure. For instance, an example machine-learned model can include a machine-learned content generation model 110, or a model used by input builder 106 or validator 600.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types.

In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 800 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 800 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

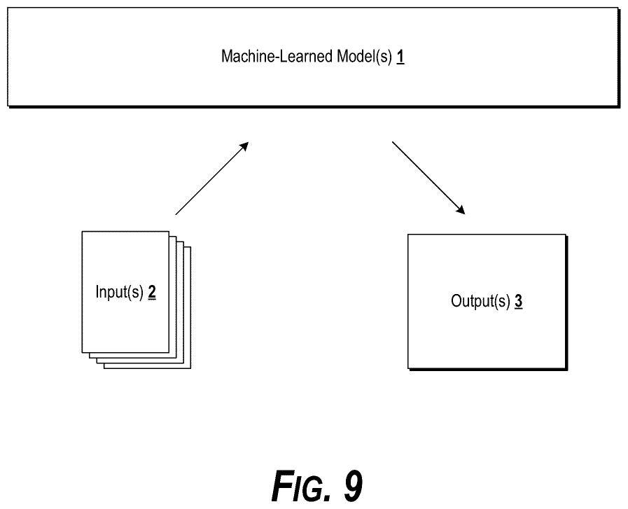

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of machine-learned content generation models 110, input builder 106, etc. Although various features, variations, and implementations described below are described with respect to machine-learned model(s) 1, it is to be understood that such features, variations, and implementations are to be understood as described with respect to each of machine-learned content generation models 110, input builder 106, etc., or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

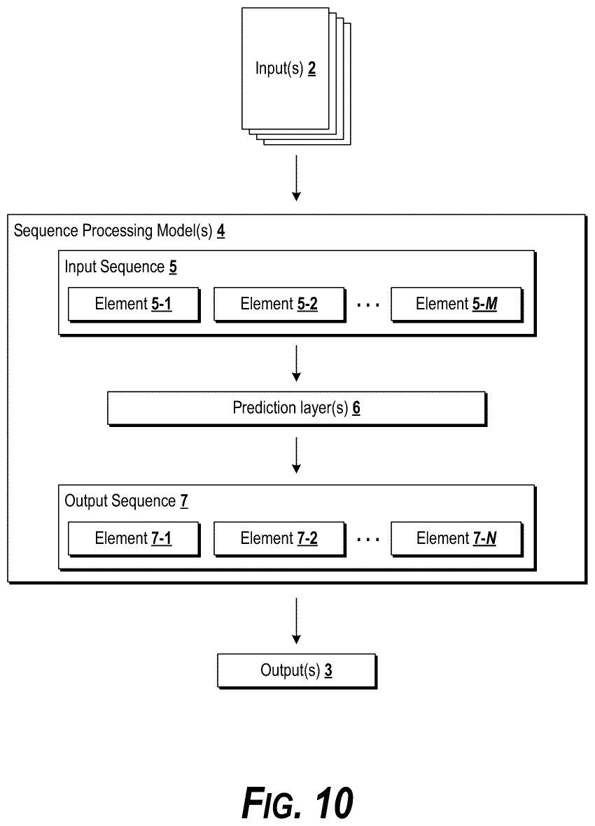

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

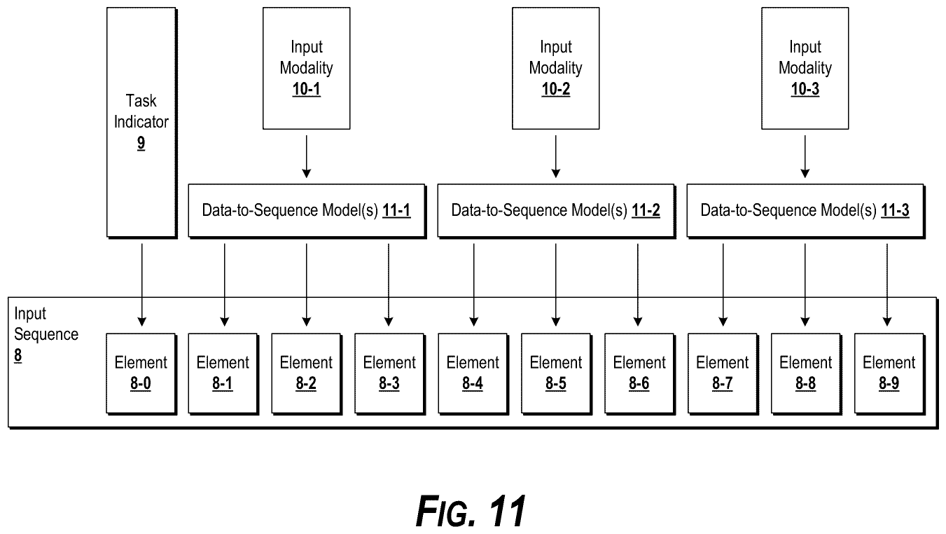

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

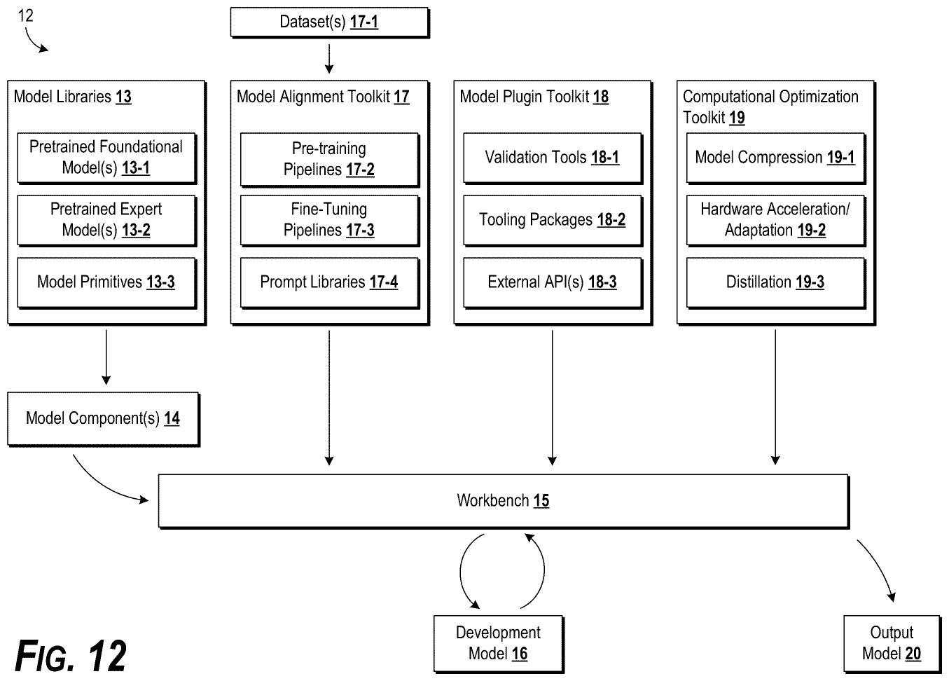

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

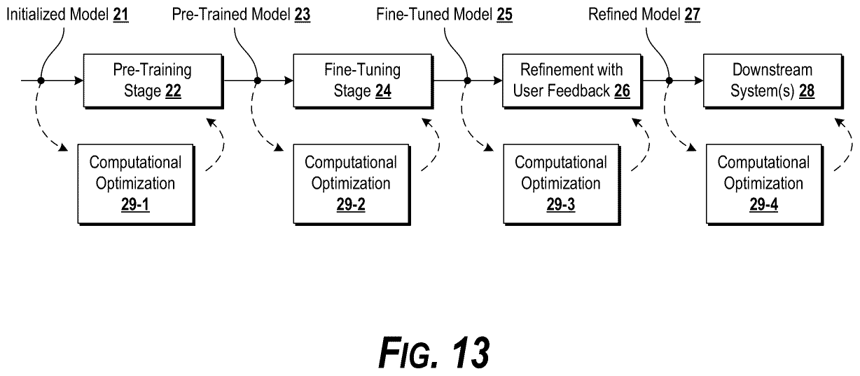

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

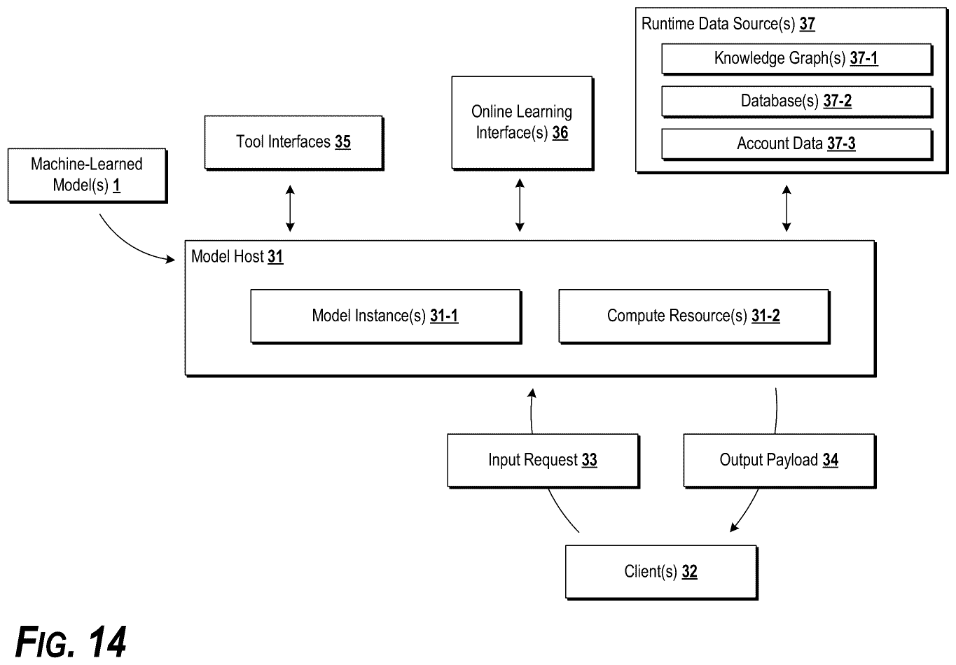

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

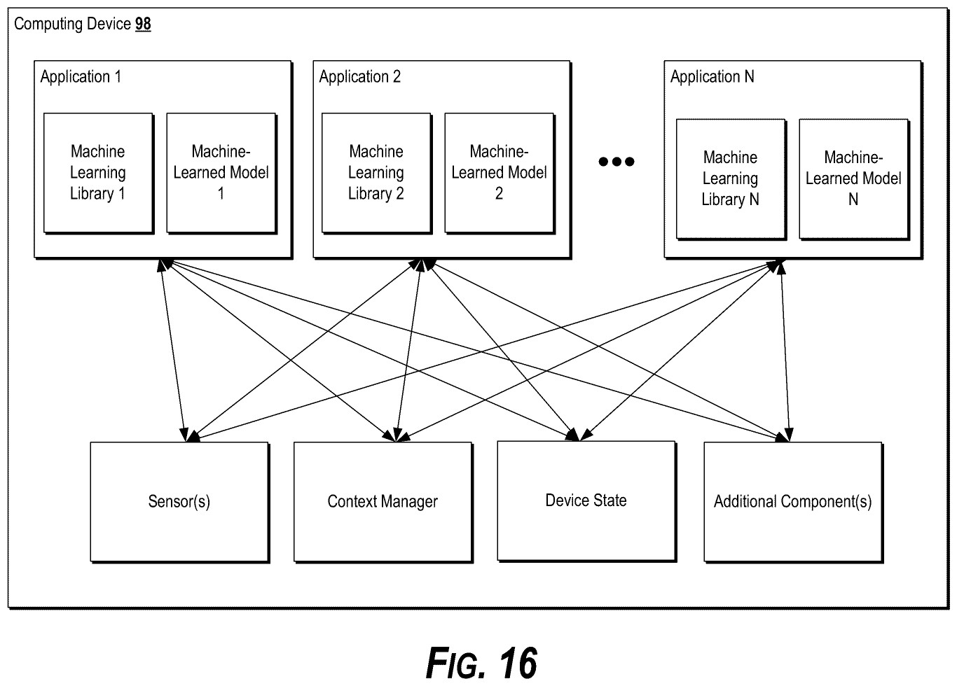

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

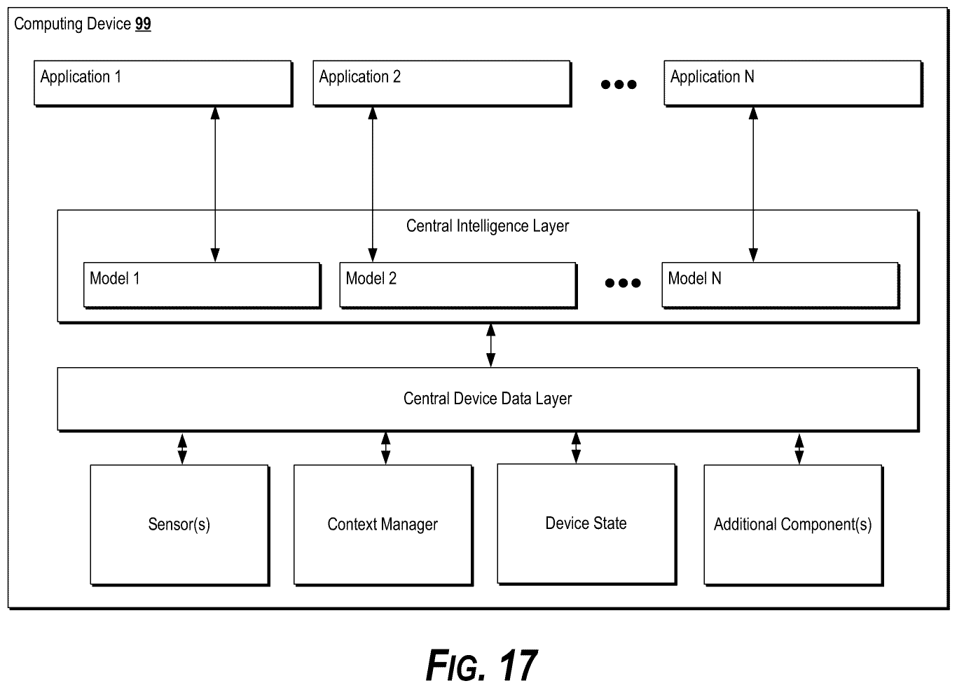

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method, comprising:
receiving request data indicating a request for content;
determining a request context associated with the request data, wherein the request context is based on account data for a user device associated with the request;
determining, based on the request and the request context, a data object from a knowledge graph, wherein the data object comprises a subject and one or more attributes for the subject; and
generating, using a machine-learned content generation model, content descriptive of the subject, the content generated based on the request, the request context, and the data object.

2. The computer-implemented method of claim 1, comprising:
transmitting the content to the user device.

3. The computer-implemented method claim 1, comprising:
generating, based on the request and the request context, input data for input to the machine-learned content generation model, wherein the input data is configured to cause the content generated by the machine-learned content generation model to describe the subject using the one or more attributes for the subject.

4. The computer-implemented method of claim 1, comprising:
generating, using a machine-learned model and based on the request data and the request context, a query for querying the knowledge graph to obtain the data object.

5. The computer-implemented method of claim 1, comprising:
obtaining preferences associated with an entity corresponding to the content; and
generating the content according to the preferences.

6. The computer-implemented method of claim 5, comprising:
providing a user interface that facilitates entry of the preferences.

7. (canceled)

8. The computer-implemented method of claim 5, wherein the content is packaged with a hyperlink to a web resource associated with the entity.

9. The computer-implemented method of claim 5, comprising:
processing the generated content to verify that it is consistent with the preferences, wherein processing the generated content to verify that it is consistent with the preferences comprises:
at least one of:
processing image data with an optical character recognition system to extract text; or
processing audio data with a speech recognition system to extract text;
and at least one of:
parsing text of the generated content to compare against the preferences; or
parsing text of the generated content to identify any excluded terms.

10. (canceled)

11. (canceled)

12. (canceled)

13. (canceled)

14. The computer-implemented method of claim 9, comprising:
based on detecting a deviation from the preferences, initiating regeneration of the content.

15. (canceled)

16. The computer-implemented method of claim 14, wherein initiating regeneration comprises editing input data for the machine-learned content generation model, wherein editing the input data for the machine-learned content generation model comprises:
updating a prompt to include an instruction regarding the detected deviation;
updating the prompt to include an instruction to correct the detected deviation; or
updating the prompt to include an instruction providing the detected deviation as a negative example.

17. (canceled)

18. (canceled)

19. (canceled)

20. (canceled)

21. The computer-implemented method of claim 1, comprising:
parsing data comprising at least one of: text of the generated content, image data of the generated content, or audio data of the generated content;
comparing the parsed data with at least one of: input data for the machine-learned content generation model, the request data, the request context, or a portion of the data object.

22. The computer-implemented method of claim 1, comprising:
parsing the generated content to identify the subject and the one or more attributes.

23. The computer-implemented method of claim 1, wherein the request context comprises data indicative of an environment in which the user device is located.

24. The computer-implemented method of claim 1, comprising:
generating the knowledge graph, wherein generating the knowledge graph comprises:
receiving a starting page indicative of an entity's webpage;
traversing a plurality of pages associated with the starting page;
obtaining the subject and the one or more attributes for the subject based on at least a portion of the plurality of pages, wherein at least one of the one or more attributes is the entity;
generating the data object comprising the subject and one or more attributes for the subject; and
storing the data object in the knowledge graph based on the one of the one or more attributes that is the entity.

25. The computer-implemented method of claim 1, wherein obtaining the subject and the one or more attributes for the subject is performed by processing webpage content with a machine-learned model to output the subject and the one or more attributes.

26. The computer-implemented method of claim 5, wherein obtaining the subject and the one or more attributes for the subject comprises:
determining, based on one or more of the preferences associated with the entity, an authorization to obtain the subject and the one or more attributes.

27. The computer-implemented method of claim 1, comprising:
caching the generated content; and
serving the cached generated content to another user device based on determining a relevance between request data for the other user device and the cached generated content.

28. One or more non-transitory computer-readable media storing instructions that are executable by one or more processors to cause a computing system to perform operations, the operations comprising:
receiving request data indicating a request for content;
determining a request context associated with the request data, wherein the request context is based on account data for a user device associated with the request;
determining, based on the request and the request context, a data object from a knowledge graph, wherein the data object comprises a subject and one or more attributes for the subject; and
generating, using a machine-learned content generation model, content descriptive of the subject, the content generated based on the request, the request context, and the data object.

29. A computing system comprising:
one or more processors; and
one or more non-transitory computer-readable media storing instructions that are executable by the one or more processors to cause the computing system to perform operations, the operations comprising:
receiving request data indicating a request for content;
determining a request context associated with the request data, wherein the request context is based on account data for a user device associated with the request;
determining, based on the request and the request context, a data object from a knowledge graph, wherein the data object comprises a subject and one or more attributes for the subject; and
generating, using a machine-learned content generation model, content descriptive of the subject, the content generated based on the request, the request context, and the data object.

30. The computing system of claim 29, wherein the operations comprise:
generating the knowledge graph, wherein generating the knowledge graph comprises:
receiving a starting page indicative of an entity's webpage;
traversing a plurality of pages associated with the starting page;
obtaining the subject and the one or more attributes for the subject based on at least a portion of the plurality of pages, wherein at least one of the one or more attributes is the entity;
generating the data object comprising the subject and one or more attributes for the subject; and
storing the data object in the knowledge graph based on the one of the one or more attributes that is the entity;
obtaining preferences associated with an entity corresponding to the content; and
generating the content according to the preferences;
processing the generated content to verify that it is consistent with the preferences, wherein processing the generated content to verify that it is consistent with the preferences comprises:
at least one of:
processing image data with an optical character recognition system to extract text; or
processing audio data with a speech recognition system to extract text;
and at least one of:
parsing text of the generated content to compare against the preferences; or
parsing text of the generated content to identify any excluded terms.
